(19) United States
(12) Patent Application Publication
(10) Pub. No.: US 2024/0268269 A1
(43) Pub. Date: Aug. 15, 2024

(54) SYSTEM FOR ACTUATING AND CONTROLLING AGRICULTURAL PLATFORMS

(71) Applicant: GTS DO BRASIL LTDA., Lages, SC (BR)

(72) Inventor: Assis STRASSER, Lages, SC (US)

(21) Appl. No.: 18/042,488

(22) PCT Filed: Aug. 11, 2021
(86) PCT No.: PCT/BR2021/050336

§ 371 Date: Mar. 22, 2023

(30) Foreign Application Priority Data
Aug. 25, 2020 (BR) 1020200173634

(51) Int. Cl. A01D 41/14; A01D 41/127; A01D 45/02

(52) U.S. Cl. CPC A01D 41/142; A01D 41/127; A01D 45/021

(57) ABSTRACT

An Electric Drive and Controlling System for Agricultural Platforms (1) that drives and controls the other mobile elements of the platform responsible for cutting, collecting and transferring the crop to the combine harvester, preferably applied to cutting platforms of agricultural crops, such as maize and cereals. The transmission mechanical system of movement commonly used in such platforms has been replaced and has, in one of its preferred configurations: a generator (1.1); a control module (1.2); a speed sensor (1.3); and a plurality of electric motors (1.4).

### FIELD OF THE INVENTION

The present invention is addressed to the field of agriculture, more precisely to the field of development and implementation of agricultural machinery for harvesting.

### BACKGROUNDS OF THE INVENTION

It is common knowledge that agriculture, and its effectiveness, arouses enormous interest in the development of cultivation techniques and machinery necessary for production. Over the years, a large number of machines have been created for planting and harvesting crops in order to improve execution and increase their success.

Harvesting machines are of great importance for commercial agriculture, because, with their use, it is possible to harvest in a much faster way compared to a manual harvesting performed by rural workers. These machines essentially comprise cutting platforms and combine harvesters. Combine harvesters are tractors that have the capacity to receive the harvested crop, separate the product with economic value (for example: grains) from the disposable material (for example: straws) and store the product.

The combine harvesters have, in their front, a feed channel where the harvested material is introduced. The cutting platform is coupled to the feed channel, adapted to the type of harvested crop, which cuts and transports the crop to the combine harvester feed channel.

The combine harvester feed channel also has, on its sides, transmission shafts that are connected to cardan shafts of the agricultural platform, in which the rotational movement of the combine harvester transmission shafts is transmitted to the cardan shafts of the agricultural platform that, in turn, transmit the movement to the other elements of the agricultural platform, thus driving and duly operating the agricultural platform with the mechanical transmission coming from the combine harvester.

The mechanical transmission system of movement is commonly used on agricultural platforms. There is no electrical transmission system of the state of the art to drive agricultural platforms, mainly because agricultural machines are robust and have low added value.

Agricultural crop cutting platforms have little added value and can be considered as an extension of combine harvesters—which have onboard control and monitoring systems. The present invention aims at raising the level of control and automation of the platforms independently of the systems contained in the combine harvesters.

### STATE OF THE ART

Document EP1935226 presents a driver for the cutting system of an agricultural platform, in which one of the possibilities for the driver is to be configured with the presence of an electric motor. The document does not present a solution for the electrical driving of the other elements of the agricultural platform as the present invention, only for the platform cutting system.

Document U.S. Pat. No. 8,931,245 describes an individual electrical drive system for cutting discs that allows the individual adjustment of the speed and/or direction of rotation of each cutting disc. The document does not present a solution for the electrical driving of the other elements of the agricultural platform as the present invention, only for the platform cutting system.

There is no document in the patent literature that presents an electrical drive, control and monitoring system for cutting systems, side conveyor belts, central conveyor belt and auger of an agricultural platform, as the present invention. Each of these systems has particularity in its driving, control and monitoring.

### BRIEF DESCRIPTION OF THE INVENTION

The present invention presents an Agricultural Platform Drive and Control System (1) that drives and controls the other mobile elements of the platform responsible for performing the cutting, collection and transfer of the crop to the combine harvester, and is preferably applied to cutting platforms of agricultural crops, such as maize and cereals. The present invention replaces the mechanical transmission system of movement commonly used in such platforms, and comprises, in one of its preferred configurations: a generator (1.1); a control module (1.2); a speed sensor (1.3); and a plurality of electric motors (1.4).

### BRIEF DESCRIPTION OF THE FIGURES

To obtain a full and complete view of the object of this invention, the figures to which references are made are presented, as follows.

FIG. 1 shows a perspective view of an agricultural platform for cutting cereal crops, one of the possibilities for implementing the present invention.

FIG. 2 shows the rear perspective view of an agricultural platform for cutting cereal crops, one of the possibilities for implementing the present invention.

FIG. 3 shows the interaction of the system elements, in one of their preferred configurations, with the platform elements driven and controlled by the system.

FIG. 4 shows a representation of a possible positioning of the elements of the system of the present invention, in one of its preferred configurations.

FIG. 5 shows the perspective view of an agricultural platform for cutting cereal crops without the fairing elements and with the present invention duly implemented, in one of its preferred configurations.

FIG. 6 shows the rear perspective view of an agricultural platform for cutting cereal crops without the fairing elements and with the present invention duly implemented, in one of its preferred configurations.

FIG. 7 shows the rear central part of the agricultural platform for cutting cereal crops without the fairing elements, connected to the combine harvester feed channel and with the present invention duly implemented, in one of its preferred configurations.

FIG. 8 shows the rear central part of the agricultural platform for cutting cereal crops without the fairing elements and with the present invention duly implemented, in one of its preferred configurations.

FIG. 9 shows the front central part of the agricultural platform for cutting cereal crops without the fairing elements and with the present invention duly implemented with an auger detail, in one of its preferred configurations.

FIG. 10 shows the front central part of the agricultural platform for cutting cereal crops without the fairing elements and with the present invention duly implemented with the central conveyor belt detailed, in one of its preferred configurations.

FIG. 11 shows one of the ends of the agricultural platform for cutting cereal crops without the fairing elements and with the present invention duly implemented with the side conveyor belt and cutting system detailed, in one of its preferred configurations.

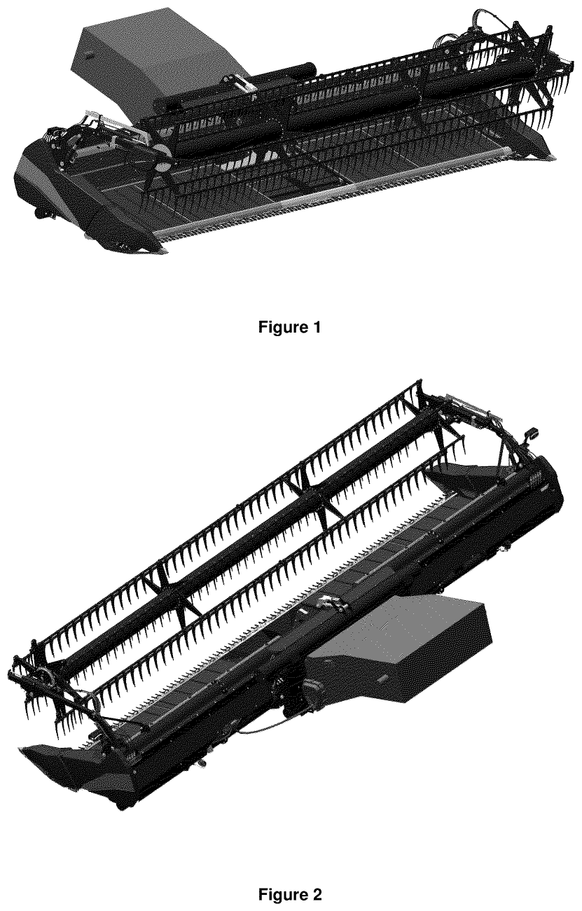

### DETAILED DESCRIPTION OF THE INVENTION

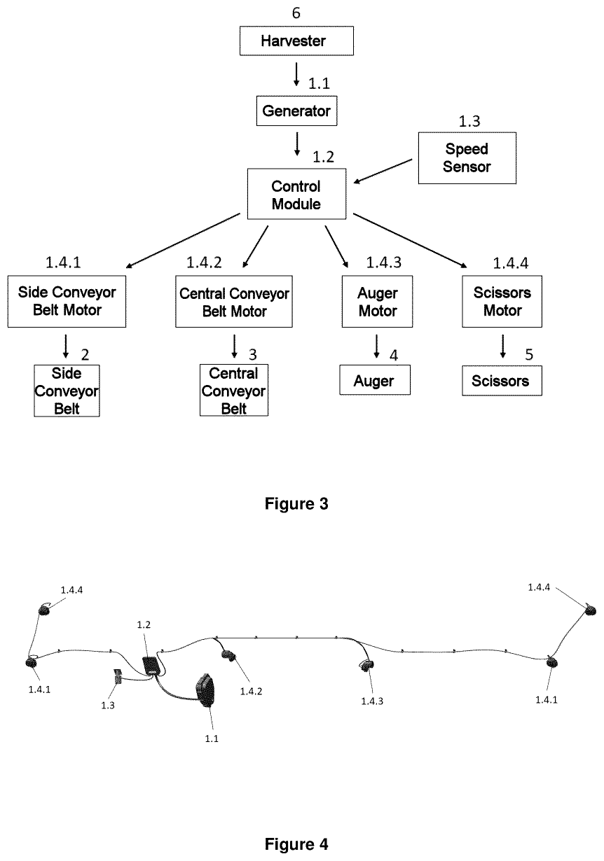

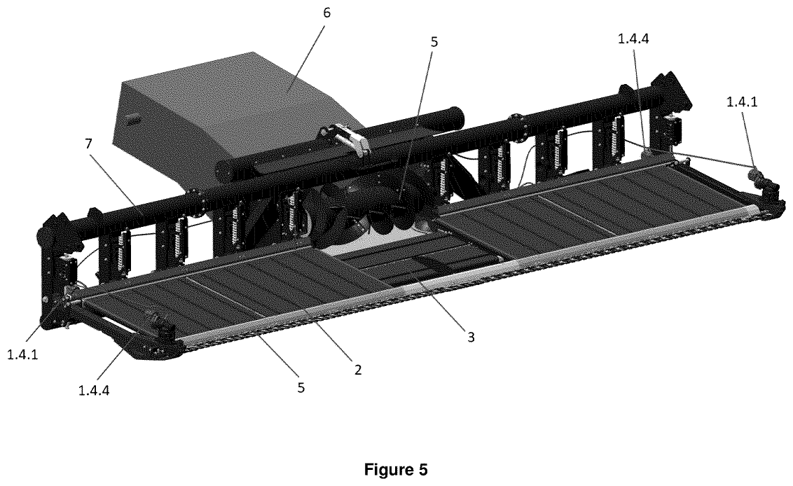

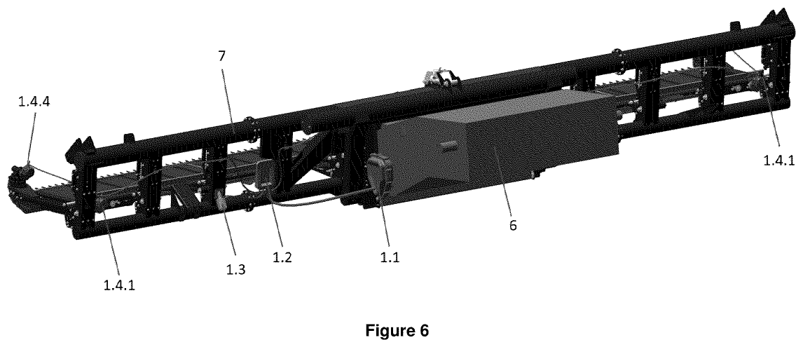

The present invention presents an Electrical System for Driving and Controlling Agricultural Platforms (1) that drives and controls the other mobile elements of the platform responsible for cutting, collecting and transferring the crop to the combine harvester, as seen in FIGS. 3, 4, 5, and 6. The present invention replaces the mechanical transmission system of movement commonly used in such platforms, it is preferably applied to platforms for cutting agricultural crops such as corn and cereals, and comprises, in one of its preferred configurations: a generator (1.1); a control module (1.2); a speed sensor (1.3); and a plurality of electric motors (1.4).

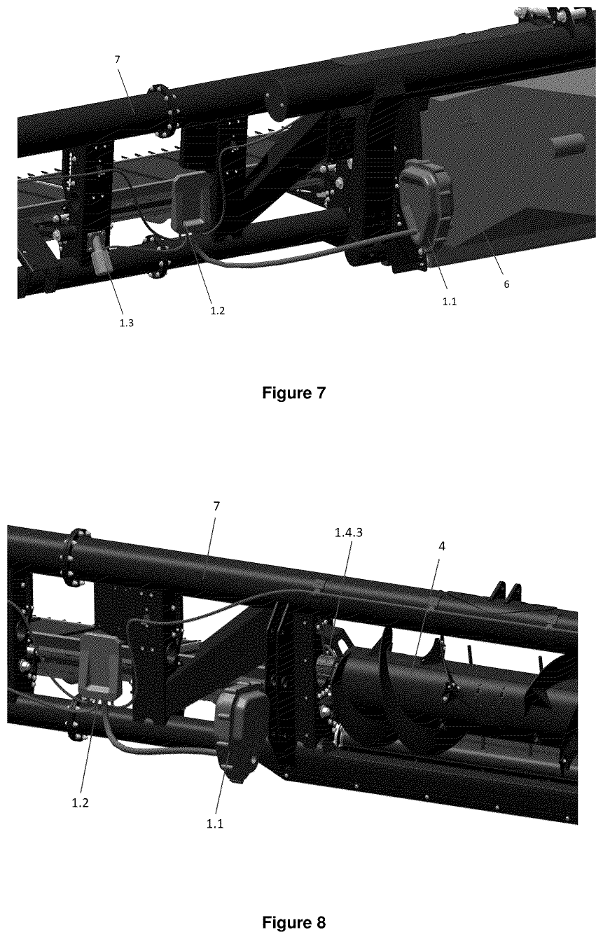

The generator (1.1), as seen in FIG. 7, has the function of generating the electrical energy that powers the other elements of the system (1), is connected to the transmission shaft of the combine harvester feed channel and, with the rotation of the same, transforms the mechanical energy provided by the transmission shaft into electrical energy and transmits this electrical energy to the control module (1.2).

The control module (1.2), as seen in FIG. 7, receives information on the platform displacement speed from the speed sensor (1.3), and with this information controls the operating speed of the motors (1.4), in addition to powering electrically the same and being attached to the platform structure and being electrically powered by the generator (1.1).

As the system (1) controls different motors (1.4), which drive different elements of the platform, the control module (1.2) controls each individually, allowing the proper functioning of each of the elements according to their functions.

The speed sensor (1.3), as seen in FIG. 7, has the function of precisely sensing the platform displacement speed during crop harvesting and providing this information to the control module (1.2) so that it can be possible to adjust the operating speed of the motors (1.4), making the same work according to the movement of the platform. The speed sensor is attached to the platform structure.

The motors (1.4), as seen in FIGS. 8, 9, 10, and 11, have the function of driving the operation of the other mobile elements of the platform responsible for performing the cutting, collection and transfer of the crop to the combine harvester.

Agricultural platforms can have different configurations and arrangements depending on the crop to be harvested, and the cutting systems transferring the harvested crop can be carried out in numerous ways. The system (1) can be implemented on all cutting and harvesting platforms, regardless of the crop to be harvested and the composition of the elements thereof.

To illustrate one of the possibilities of implementing the present invention, there is used as an example a cutting platform addressed to the harvesting of grains comprising a cutting system with scissors, conveyor belts for transferring the crop to the central part of the platform and an auger (helicoid) to collect the crop by moving the same to the combine harvester feed channel. However, the system (1), as mentioned, is not limited to this application.

For this type of platform, the system comprises, preferably, six motors (1.4): two motors for the side conveyor belts (1.4.1); a center conveyor belt motor (1.4.2); an auger motor (1.4.3); and two cutting system motors (1.4.4).

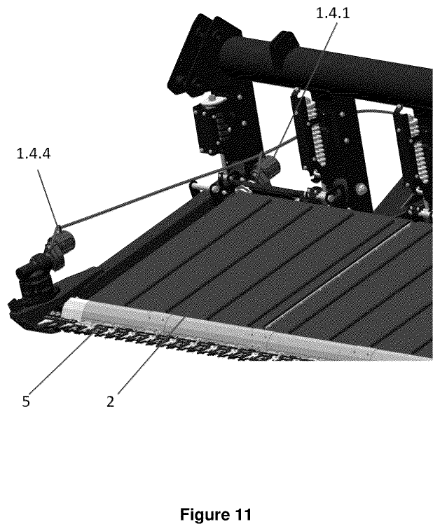

The motors of the side conveyor belts (1.4.1), as seen in FIG. 11, are installed in the platform structure and drive the operation of the side conveyor belts (2).

The central conveyor belt motor (1.4.2), as seen in FIG. 10, is installed in the platform structure and drives the operation of the central conveyor belt (3).

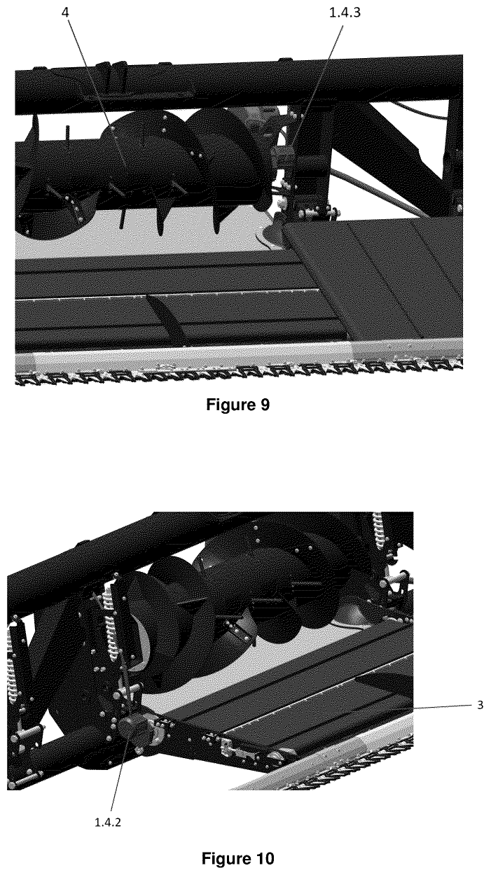

The auger motor (1.4.3), as seen in FIG. 9, is installed in the platform structure and drives the operation of the auger (4).

The cutting system motors (1.4.4), as shown in FIG. 11, are installed on the platform structure and drive the operation of the cutting system (5).

Those skilled in the art will value the knowledge presented here and will be able to reproduce the invention in the presented embodiments and in other variants, encompassed by the scope of the appended claims.

1. An Electrical Drive and Control System for Agricultural Platform (1) configured to drive and control mobile elements of the platform responsible for cutting, collecting and transferring crop to a combine harvester, wherein the platform comprises:
a generator (1.1); a control module (1.2); a speed sensor (1.3); and a plurality of electric motors (1.4).

2. The system (1) according to claim 1, wherein the generator (1.1) is connected to a transmission shaft of the combine harvester feed channel, transforms the mechanical energy provided by the transmission shaft into electrical energy and transmits the electrical energy generated for the control module (1.2).

3. The system (1) according to claim 1, wherein the control module (1.2) receives information about a displacement speed of the platform from the speed sensor (1.3), controls an operating speed of the plurality of electric motors (1.4), electrically powers the plurality of electric motors, is attached to the platform and is electrically powered by the generator (1.1).

4. The system (1) according to claim 3, wherein the control module (1.2) controls each of the plurality of electric motor (1.4) individually.

5. The system (1) according to claim 1, wherein the speed sensor (1.3) is attached to the platform, senses the platform displacement speed during crop harvesting and provides this information to the control module (1.2).

6. The system (1) according to claim 1, wherein the plurality of electric motors (1.4) drive the operation of the mobile elements of the platform responsible for performing the cutting, collection and transfer of the crop to the combine harvester.

7. The system (1) according to claim 6, wherein the plurality of electric motors comprises motors of a side conveyor belts (1.4.1) are installed in the platform and drive the operation of the side conveyor belts (2).

8. The system (1) according to claim 6, wherein the plurality of electric motors comprises a central conveyor belt motor (1.4.2) installed in the platform and drives the operation of the central conveyor belt (3).

9. The system (1) according to claim 6, wherein the plurality of electric motors comprises an auger motor (1.4.3) installed in the platform and drives the operation of the auger (4).

10. The system (1) according to claim 6, wherein the plurality of electric motors comprises cutting system motors (1.4.4) installed on the platform and drive the operation of the cutting system (5).
